(19) United States
(12) Patent Application Publication
(10) Pub. No.: US 2012/0170127 A1
(43) Pub. Date: Jul. 5, 2012

(54) REFLECTIVE DISPLAY DEVICE

(76) Inventors: Stephen Kitson, Alveston (GB); Timothy Taphouse, Thornbury (GB); Tim R. Koch, Corvallis, OR (US)

(21) Appl. No.: 13/260,220

(22) PCT Filed: Jun. 18, 2009
(86) PCT No.: PCT/US09/47759

§ 371 Date: Nov. 9, 2011

(51) Int. Cl. G02B 5/22

(52) U.S. Cl. 359/614

(57) ABSTRACT

Various reflective display devices are provided. In one embodiment, a reflective display device is provided that includes a first controllable light absorption layer capable of absorbing incident light in a first specified wavelength band and at least a second specified wavelength band and a first reflector behind the first absorption layer, which is capable of selectively reflecting at least some wavelengths of light within the first and second specified wavelength bands and substantially transmit light of other wavelengths. The reflective display device further includes a second controllable light absorption layer behind the selective reflector, which is capable of absorbing incident light in at least a third specified wavelength band and a second reflector behind the second layer, which is capable of reflecting at least some wavelengths of light within the third specified wavelength band.

### BACKGROUND

A reflective display is a non-emissive device in which ambient light is used for viewing the displayed information. Rather than light from behind the display being transmitted through the display, light is reflected from the display back to a viewer. The reflected light passes through each of a number of layers of the reflective display twice, which can reduce the efficiency because of unwanted absorption by extra layers.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a graphical representation of a three-layer reflective display device;

FIG. 2 is a graphical representation of a two-layer reflective display device according to an embodiment of the present invention;

FIG. 3 is a graphical representation of a two-layer reflective display device including an interlayer reflector according to an embodiment of the present invention.

### DETAILED DESCRIPTION

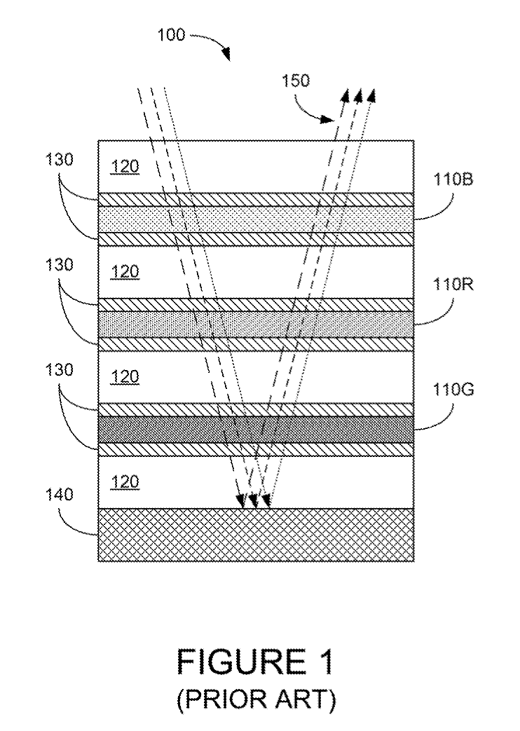

Reflective display devices can include a stack of absorption layers with each layer configured to selectively absorb light within a specific wavelength band. FIG. 1 depicts a reflective display device 100, which includes a stack of three selective absorption layers 110B, 110R, and 110G. In the embodiment of FIG. 1, a layer 110B for absorbing blue light is at the top of the stack, a layer 110R for absorbing red light is below layer 110B, and a layer 110G for absorbing green light is at the bottom of the stack. In some embodiments, individual layers can be made to absorb the blue, red, and green light, respectively.

In the embodiment of FIG. 1, each absorption layer 110 is sandwiched between transparent substrates 120 and transparent conductors 130. The layers 110 can be wholly or partially activated by the application of suitable electric signals via the conductors 130. Thus, selected pixel regions of each absorption layer 110 may be made to either absorb light within the specific wavelength band or substantially transmit all incident light. A silver mirror 140 functions as a broadband reflector which reflects light of all wavelengths 150. The silver mirror 140 is disposed at the bottom of the device 100 and reflects incident light back through the layers 110, 120, and 130 to the viewer.

In this embodiment, light 150 that is reflected from the display device 100 back to the viewer passes through a conductor layer 130 twelve times (twice for each of the six conductors 130). If aperture issues are ignored, the best reflectivity is determined by the losses in conductors 130 and the reflectivity of the silver mirror 140. Translucent conductors can include, but are not limited to, indium tin oxide (ITO) or poly(3,4-ethylenedioxythiophene)poly(styrenesulfonate) (Pedot-PSS).

Given a conductor transmission of approximately 97.5% and a silver reflectivity of approximately 92%, the expected peak reflectivity of the reflective display device 100 can be estimated as 0.92×(0.975)¹², which is approximately 68%. In contrast, the reflectivity of paper is in the range of about 80%. By reducing the number of layers that the reflected light passes through, the reflectivity of the display can be increased.

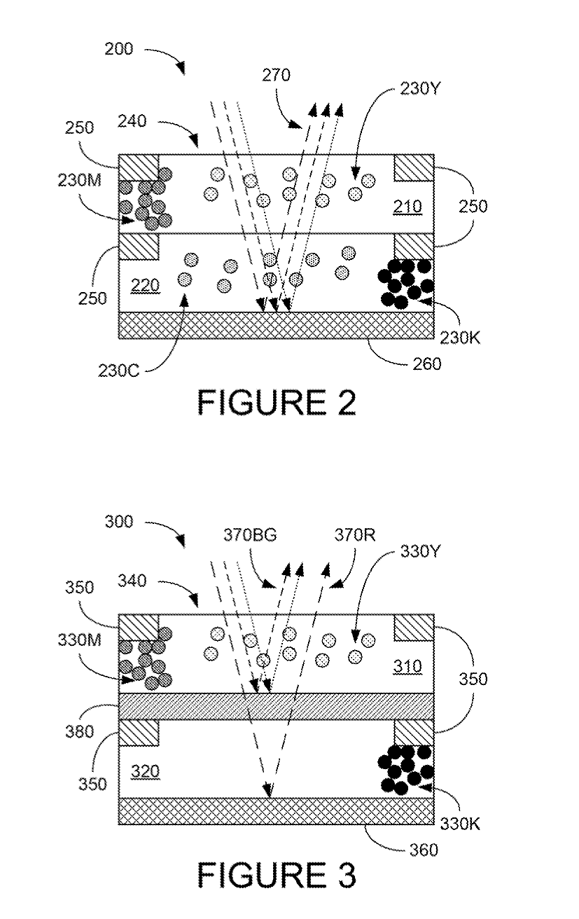

FIG. 2 is a graphical representation of a two-layer reflective display device 200. In the embodiment of FIG. 2, two controllable light absorption layers 210 and 220 are stacked, one behind the other, to form a single display. Each layer 210 and 220 includes two colorants 230 that can be switched (or controlled) within the layer to control absorption of incident light. For example, the colorants can either be swept into the viewed area 240 or concentrated into small areas and potentially hidden under opaque regions such as electrode structures 250. In some embodiments, among others, the colorants are individually controlled. When a colorant is switched into the viewed area 240, incident light within the wavelength band of the colorant is absorbed and prevented from being reflected back to the viewer. A diffuse reflector 260 is included behind the light absorption layers to reflect incident light 270 back towards the viewer.

In one embodiment, among others, pigments such as, but not limited to, electrophoretic pigments, are utilized as colorants 230. Cyan, yellow and magenta pigments may be used to absorb wavelengths of red, blue and green light, respectively. In addition, a black pigment can be included to ensure a dark neutral black point. For example, in the embodiment of FIG. 2, the first light absorption layer 210 includes yellow and magenta pigments (230Y and 230M respectively) and the second light absorption layer 220 includes cyan and black pigments (230C and 230K respectively). This arrangement allows the full range of colors to be displayed at all points on the display.

By reducing the number of layers to two, the efficiency of the reflective display can be increased by reducing the losses associated with each additional layer. However, in the embodiment of FIG. 2, the reflected light 270 passes through both layers 210 and 220 before returning to the viewer. By using an interlayer reflector, which is adapted to reflect light within the wavelength bands of the colorants in the first layer, at least some of the light is reflected before it reaches the second layer. Reducing the number of layers that a portion of the light passes through further improves the efficiency of the display device. In addition, the number of colorants 230 needed to display the full range of colors can be reduced to just three. Also, the disclosed configuration allows for more design freedom in the selection of the single colorant in the second layer.

FIG. 3 is a graphical representation of a two-layer reflective display device 300 including an interlayer reflector 380. In the embodiment of FIG. 3, there are two colorants 330 in the first layer 310. The first colorant is adapted to absorb incident light within a first wavelength band and the second colorant is adapted to absorb incident light within a second wavelength band. In some embodiments, the first and second wavelength bands may overlap. The second layer 320 includes a single colorant 330 adapted to absorb incident light within at least a third wavelength band corresponding to the colorant included in the second layer 320. In some embodiments, the'third wavelength band may overlap one or both of the first and second wavelength bands. The choice of which colorants go in each layer may be based upon the spectral properties of the available colorants.

In the exemplary embodiment of FIG. 3, yellow and magenta pigments (330Y and 330M respectively) are in the first layer 310. In this way, absorption of light within first and second bandwidths corresponding to blue and green light, respectively, may be controlled by controlling the amount of colorant swept into the viewed area 340 or concentrated into small areas and potentially hidden under opaque regions such as electrode structures 350. While the example of FIG. 3 depicts the colorants as particles, other embodiments may utilize colored fluids to control absorption of the incident light.

Positioned between the first and second layers (310 and 320) is an interlayer reflector 380 adapted to selectively reflect at least some wavelengths of light within the first and second wavelength bands. Light of other wavelengths (i.e., light outside the first and second wavelength bands) is substantially transmitted through the interlayer reflector 380 to the second layer 320. A single colorant can be switched (or controlled) within the second layer 320 to control absorption of the transmitted light within a third bandwidth. When the colorant is switched into the viewed area 340, incident light within the wavelength band of the colorant is absorbed and prevented from being reflected back to the viewer. A second reflector 360 is included behind the light absorption layers 310 and 320 to reflect at least some wavelengths of unabsorbed light within the third wavelength band back towards the viewer.

In the embodiment of FIG. 3, the interlayer reflector 380 is depicted as a single reflector that reflects wavelengths of blue-green light 370BG, while allowing wavelengths of red light 370R to be transmitted to the second layer 320. Because blue and green light 370BG are reflected by the interlayer reflector 380 without having to pass through the second layer 320, they will experience less loss and the efficiency and brightness of the reflective display 300 can be improved. In other embodiments, the interlayer reflector 380 may include two or more reflectors, each adapted to reflect at least a portion of the first or second wavelength bands and substantially transmitting light of other wavelengths.

For example, multilayer Bragg mirrors may be utilized as an interlayer reflector 380. Multilayer Bragg mirrors are made from alternating layers of materials with different refractive indices. In order to reflect a particular wavelength, the layer thicknesses are set at a quarter wave thick. Such mirrors give a wavelength selective reflection determined by the thickness of the layers and the difference in refractive index between the layers. To make them slightly diffuse, the mirrors can be slightly roughened by applying the coating on a roughened surface as discussed below.

Other colorant combinations that may also be used in the first layer 310 include, but are not limited to, magenta and cyan pigments or yellow and cyan pigments. Accordingly, the interlayer reflector would be adapted to reflect wavelengths of green-red or blue-red light, respectively.

Light of wavelengths that are not absorbed in the first layer 310 or reflected by the interlayer reflector are transmitted to the second layer 320. In one exemplary embodiment, a black pigment (330K) capable of absorbing wavelengths within all bands is used as the colorant in the second layer 320. Alternatively, in the exemplary embodiment of FIG. 3 where wavelengths of red light reaches the second layer 320, a colorant may be used that absorbs at least wavelengths of red light. If the absorption of the colorant extends further into the range of blue light, it will not produce a problem with color control as those shorter wavelengths will already have been reflected at the interlayer reflector 380. This allows a wider range of freedom in the choice of a pigment for the second layer 320. For example, pigments with absorption spectra that would not normally be considered because they are not limited to absorbing only wavelengths of red light may still be used in this architecture. For the exemplary embodiment of FIG. 3, table 1 illustrates how pigments 330Y, 330M, and 330K can be combined in the field of view 340 to generate a plurality of colors that can be perceived by a viewer. When the indicated combination of pigments is swept into the viewing area of the first layer 310 and second layer 320, the color indicated on the left will be displayed. Blank entries (*) indicate that no pigment is swept into the viewing area.

| | First layer 310 | Second layer 320 |
|---|---|---|
| White | * | * |
| Black | 330Y + 330M | 330K |
| Blue | 330M | 330K |
| Green | 330Y | 330K |
| Red | 330Y + 330M | * |
| Yellow | 330Y | * |
| Magenta | 330M | * |
| Cyan | * | 330K |

Transmitted light that is not absorbed in the second layer is reflected by the second reflector 360. In the embodiment of FIG. 3, a diffuse reflector 360 is included behind the light absorption layers to reflect incident light 370R back towards the viewer. For example, a silver mirror may be used as the second reflector 360. Other embodiments may coat a rough surface with a multilayer dielectric mirror stack to produce a diffuse reflector. The rough surface can be made by imprinting from a suitable master onto a plastic substrate. The period and amplitude of the roughness controls the viewing angle and gain of the display. The design of the multilayer coating controls the spectral properties. Alternatively, the second reflector 360 can be adapted to selectively reflect at least some wavelengths of light within the third wavelength band. For example, at least some wavelengths of red light 370R may be reflected by the second reflector 360, while light of other wavelengths are substantially transmitted through the reflector 360. The color gamut of the display will be controlled by the reflectivity of the first interlayer reflector and the second back side reflector, and by the absorption spectra and concentrations of the pigments.

Therefore, having thus described the invention, at least the following is claimed:

1. A reflective display device, comprising:
a first controllable light absorption layer capable of absorbing incident light in a first specified wavelength band and at least a second specified wavelength band;
a first reflector behind the first absorption layer, the first reflector capable of selectively reflecting at least some wavelengths of light within the first and second specified wavelength bands and substantially transmit light of other wavelengths;
a second controllable light absorption layer behind the selective reflector, the second absorption layer capable of absorbing incident light in at least a third specified wavelength band; and
a second reflector behind the second layer, the second reflector capable of reflecting at least some wavelengths of light within the third specified wavelength band.

2. The reflective display device of claim 1, wherein the first absorption layer comprises a first colorant capable of absorbing light in at least the first specified wavelength band and a second colorant capable of absorbing light in at least the second specified wavelength band.

3. The reflective display device of claim 2, wherein the first colorant is a magenta pigment.

4. The reflective display device of claim 3, wherein the second colorant is a yellow pigment and the first reflector is capable of reflecting blue-green light.

5. The reflective display device of claim 3, wherein the second colorant is a cyan pigment and the first reflector is capable of reflecting green-red light.

6. The reflective display device of claim 2, wherein the first colorant is a cyan pigment, the second colorant is a yellow pigment, and the first reflector is capable of reflecting blue-red light.

7. The reflective display device of claim 2, wherein the second absorption layer comprises a single colorant capable of absorbing light in at least the third specified wavelength band.

8. The reflective display device of claim 7, wherein the third specified wavelength band overlaps the first and the second specified wavelength bands.

9. The reflective display device of claim 7, wherein the single colorant is a black pigment.

10. The reflective display device of claim 1, wherein the first reflector includes a plurality of interlayer reflectors.

11. The reflective display device of claim 10, wherein the plurality of interlayer reflectors includes:
a first interlayer reflector capable of selectively reflecting at least some wavelengths of light within the first specified wavelength band and substantially transmit light of other wavelengths; and
a second interlayer reflector capable of selectively reflecting at least some wavelengths of light within the second specified wavelength band and substantially transmit light of other wavelengths.

12. The reflective display device of claim 1, wherein the second reflector is a diffuse broadband reflector.

13. A reflective display device, comprising:
means for controlling absorption of incident light in a first specified wavelength band and at least a second specified wavelength band;
means for selectively reflecting at least some wavelengths of light within the first and second specified wavelength bands and substantially transmitting light of other wavelengths, the means for selectively reflecting located behind the means for controlling absorption of incident light in at least first and second specified wavelength bands;
means for controlling absorption of incident light in at least a third specified wavelength band, the means for controlling absorption of incident light in at least a third specified wavelength band located behind the means for selectively reflecting; and
means for reflecting at least some wavelengths of light within the third specified wavelength band, the means for reflecting located behind the means for controlling absorption of incident light in at least a third specified wavelength band.

14. The reflective display device of claim 13, wherein means for controlling absorption of incident light in at least a third specified wavelength band also absorbs incident light in at least the first specified wavelength band.

15. The reflective display device of claim 13, wherein the means for reflecting also reflects wavelengths of light in the first and second specified wavelength bands.
